(19) United States
(12) Patent Application Publication
(10) Pub. No.: US 2026/0055017 A1
(43) Pub. Date: Feb. 26, 2026

(54) SYSTEM AND METHOD FOR FORMING THIN, THREE-DIMENSIONAL SHAPED GLASS ARTICLES BY PRESSING

(71) Applicant: CORNING INCORPORATED, CORNING, NY (US)

(72) Inventors: Cyril Rémy André Dedieu, Hericy (FR); Allan Mark Fredholm, Vulaines sur Seine (FR)

(21) Appl. No.: 19/104,567

(22) PCT Filed: Aug. 16, 2023
(86) PCT No.: PCT/US2023/030304

§ 371 Date: Feb. 18, 2025

Related U.S. Application Data
(60) Provisional application No. 63/400,491, filed on Aug. 24, 2022.

(51) Int. Cl. C03B 11/08

(52) U.S. Cl. CPC C03B 11/086; C03B 2215/24

(57) ABSTRACT

A system for forming a glass article includes a mold assembly and a burner assembly. The mold assembly includes a mold body that defines an open cavity configured to receive a glass-containing material in a molten state. The mold assembly further includes a plunger configured to be actuated towards the mold body and into the open cavity to press the glass-containing material into a closed volume defined by the mold body and the plunger. The mold assembly further includes (i) first surfaces that define the closed volume and (ii) one or more pairs of second surfaces that make sliding contact when the plunger is actuated. The burner assembly is configured to form a solid lubricant on active surfaces of the mold assembly. The active surfaces include all the first surfaces and at least one second surface of each of the one or more pairs of second surfaces.

### CROSS-REFERENCE TO RELATED APPLICATIONS

This application claims the benefit of priority under 35 U.S. C. § 119 of U.S. Provisional Application No. 63/400,491 filed Aug. 24, 2022, the content of which is incorporated herein by reference in its entirety.

### FIELD

The present disclosure relates to glass pressing and, more particularly, to forming thin, three-dimensional glass articles via pressing with said articles having a net or near net shape without subsequent processing.

### BACKGROUND

Three-dimensional (3D) glass articles can be formed via a pressing process using a mold and plunger. In such a glass pressing process, a volume of molten glass from a melt (known as a “gob”) is placed at the center of the mold through an opening at the top of the mold (known as “gathering”). A ring can be located on the top of the mold to cover a portion of the opening. The plunger is configured to be inserted through the ring and moved towards the mold to compress the gob against a shaped surface of the mold. The mold, the ring, and plunger define a closed volume into which the gob is compressed during the pressing process. The movement of the plunger towards the mold reduces the closed (or compression) volume, thereby forcing the gob to conform to a desired 3D shape.

The glass pressing process is sensitive to certain parameters, including glass viscosity, the time between gob formation and the beginning of glass flow (i.e., when the plunger first contacts the gob), and the pressing force and velocity of the plunger. Pressing a gob into a thin glass article while friction exists between the glass and the press tooling can become challenging for a number of reasons. For example, such pressing means shearing a layer that is thinner and thinner with shear stress being proportional to the glass viscosity. Moreover, the pressing force significantly increases when the glass thickness decreases. Furthermore, the glass viscosity increases rapidly when the glass is cooled by contact with the press tooling and such contact is unavoidable.

Process adjustments to address some of the existing challenges when forming thin, 3D-shaped articles via pressing, such as decreasing the time between gob formation and the beginning of glass flow or increasing the plunger pressing force, are sometimes impracticable due to gathering conditions, glass properties, and/or press specifications. For instance, there is a limit to the pressing force that can be applied before resulting in defects such as individual cracks or microcracks in regions of a thin, 3D-shaped glass article formed by pressing. Consequently, it would be advantageous to modify the friction conditions between the gob and the press tooling so as to mitigate some of the existing challenges of pressing thin glass articles.

### SUMMARY

According to aspect (1), a method for forming a glass article is provided. The method comprises: forming a solid lubricant on active surfaces of a mold assembly; depositing a glass-containing material in a molten state into an open cavity of a mold body of the mold assembly after forming the solid lubricant on the active surfaces; actuating a plunger of the mold assembly towards the mold body and into the open cavity to press the glass-containing material into a closed volume defined by the mold body and the plunger to form the glass article, the closed volume having a three-dimensional shape, wherein the mold assembly comprises (i) first surfaces that define the closed volume and (ii) one or more pairs of second surfaces that make sliding contact during the actuating of the plunger, the active surfaces comprising all of the first surfaces and at least one second surface of each of the one or more pairs of second surfaces.

According to aspect (2), the method of aspect (1) is provided, wherein the solid lubricant is carbon soot formed in a continuous layer on the active surfaces.

According to aspect (3), the method of aspect (2) is provided, wherein the carbon soot is formed by thermally decomposing a hydrocarbon using a flame.

According to aspect (4), the method of aspect (3) is provided, wherein the thermally decomposing the hydrocarbon comprises selectively pulsing a supply of the hydrocarbon to a multi-port burner with the flame to form the carbon soot.

According to aspect (5), the method of aspect (4) is provided, wherein, when not pulsing the supply of the hydrocarbon, the flame is maintained by continuously supplying natural gas to the multi-port burner.

According to aspect (6), the method of any one of aspects (3) to (5) is provided, wherein the hydrocarbon is acetylene.

According to aspect (7), the method of any one of the preceding aspects is provided, wherein the closed volume decreases until the plunger is actuated to a predetermined distance from the mold body, the closed volume configured to form the glass article with a thickness of less than or equal to approximately 2 mm when the plunger is at the predetermined distance.

According to aspect (8), the method of aspect (7) is provided, wherein the thickness varies over at least a portion of the glass article.

According to aspect (9), the method of any one of the preceding aspects is provided, wherein plunger is actuated with a pressing force configured to generate a pressure of less than or equal to approximately 4.0 MPa on the glass-containing material to form the glass article.

According to aspect (10), the method of any one of the preceding aspects is provided, wherein the mold assembly further comprises a ring portion that covers a portion of the open cavity of the mold body, the ring portion defining a portion of the closed volume.

According to aspect (11), the method of aspect (10) is provided, wherein ring portion covers a peripheral portion of the open cavity of the mold body.

According to aspect (12), the method of aspect (10) or aspect (11) is provided, wherein the ring portion is separate from the mold body and the plunger, the ring portion disposed on the mold body and defining a ring opening through which the plunger moves and makes sliding contact with the ring portion during the actuating of the plunger.

According to aspect (13), a system for forming a glass article is provided. The system comprises: a mold assembly comprising a mold body and a plunger, the mold body defining an open cavity configured to receive a glass-containing material in a molten state, the plunger configured to be actuated towards the mold body and into the open cavity to press the glass-containing material into a closed volume defined by the mold body and the plunger to form the glass article, the closed volume having a three dimensional shape; and a burner assembly configured to form a solid lubricant on active surfaces of the mold assembly, the mold assembly further comprising (i) first surfaces that define the closed volume and (ii) one or more pairs of second surfaces configured to make sliding contact when the plunger is actuated towards the mold body, the active surfaces comprising all of the first surfaces and at least one second surface of each of the one or more pairs of second surfaces.

According to aspect (14), the system of aspect (13) is provided, wherein the solid lubricant is carbon soot disposed in a continuous layer on the active surfaces.

According to aspect (15), the system of aspect (14) is provided, wherein the burner assembly comprises a multi-port burner configured to form the carbon soot by thermally decomposing a hydrocarbon using a flame.

According to aspect (16), the system of aspect (15) is provided, wherein the burner assembly is configured to provide a pulsed supply of the hydrocarbon to the multi-port burner to form the carbon soot.

According to aspect (17), the system of aspect (15) or aspect (16) is provided, wherein the burner assembly is configured to provide a continuous supply of natural gas to the multi-port burner to maintain the flame.

According to aspect (18), the system of any one of aspects (15) to (17) is provided, wherein the hydrocarbon is acetylene.

According to aspect (19), the system of any one of aspects (13) to (18) is provided, wherein the closed volume decreases until the plunger is actuated to a predetermined distance from the mold body, the closed volume configured to form the glass article with a thickness of less than or equal to approximately 2 mm when the plunger is at the predetermined distance.

According to aspect (20), the system of aspect (19) is provided, wherein the thickness varies over at least a portion of the glass article.

According to aspect (21), the system of any one of aspects (13) to (20) is provided, wherein the plunger is configured to generate a pressure of less than or equal to approximately 4.0 MPa on the glass-containing material to form the glass article.

According to aspect (22), the system of any one of aspects (13) to (21) is provided, wherein the mold assembly further comprises a ring portion that covers a portion of the open cavity of the mold body, the ring portion defining a portion of the closed volume.

According to aspect (23), the system of aspect (22) is provided, wherein ring portion covers a peripheral portion of the open cavity of the mold body.

According to aspect (24), the system of aspect (22) or aspect (23) is provided, wherein the ring portion is separate from the mold body and the plunger, the ring portion disposed on the mold body and defining a ring opening through which the plunger moves and makes sliding contact with the ring portion when the plunger is actuated towards the mold body.

### BRIEF DESCRIPTION OF THE DRAWINGS

FIG. 1 is a flow chart illustrating embodiments of a method for forming a thin, three-dimensional (3D) shaped glass article via pressing;

FIG. 2 is a cross-sectional representation of aspects of the method of FIG. 1 showing a solid lubricant formed on active surfaces of a mold assembly used to form the glass article;

FIG. 3 is a cross-sectional representation of a burner assembly configured to form the solid lubricant on the active surface of the mold assembly of FIG. 2;

FIG. 4 is a cross-sectional representation of aspects of the method of FIG. 1 depicting a glass-containing material deposited into a mold body of the mold assembly;

FIG. 5 is a cross-sectional representation of aspects of the method of FIG. 1 showing a plunger of the mold assembly actuated towards the mold body of FIG. 4 to press the glass-containing material into a closed volume defined by the mold body and the plunger;

FIG. 6 is a cross-sectional representation of aspects of the method of FIG. 1 depicting the plunger of FIG. 5 retracted from the mold body to expose the glass article;

FIG. 7 is an image of a mold body according to an example with a solid lubricant formed in a continuous layer on active surfaces thereof according to Example 1;

FIG. 8 is an image of a glass-containing material deposited on the solid lubricant formed on the mold body of FIG. 7 according to Example 1;

FIG. 9 is an image of a 3D-shaped glass article completely formed after the glass-containing material of FIG. 8 was pressed with a plunger into a closed volume defined by the mold body and the plunger according to the pressing parameters of Example 1; and

FIG. 10 is an image of a 3D-shaped glass article incompletely formed after a glass-containing material was pressed with a plunger according to Example 2 and using the same mold assembly and pressing parameters of Example 1, but with the solid lubricant formed in an incomplete and/or non-continuous layer on the active surfaces of the mold body.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein, unless defined elsewhere in association with specific terms or phrases, are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein-for example up, down, right, left, front, back, top, bottom, above, below, and the like-are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Embodiments of the present disclosure relate to a system and method for forming thin, three-dimensional (3D) shaped glass articles via pressing molten glass. As used herein, “thin” refers to glass articles having a thickness of approximately 1 mm or less. Potential applications of the system and the method disclosed herein include components for the portable display device industry, such as 3D-shaped phone backs. As noted, there are existing challenges to forming relatively thin glass articles using pressing processes. For example, due to friction conditions between the glass and the tooling, a higher pressing force is needed when pressing molten glass to form thin glass articles. Furthermore, glass viscosity grows rapidly when the molten glass contacts the tooling. The system and the method disclosed herein mitigate some of the existing challenges by modifying the friction conditions between the molten glass and the tooling by forming a continuous layer of (carbon) soot obtained via thermal decomposition of hydrocarbons, such as acetylene, to form carbon/acetylene black on active surfaces of the mold assembly.

The solid lubrication formed on the active surfaces of the mold assembly beneficially changes the friction conditions and significantly reduces the pressing force (and the resulting pressing pressure on the molten glass) needed to form thin, 3D-shaped glass articles via pressing. The system and method disclosed herein are particularly useful when forming thin, 3D-shaped glass articles having large thickness variations and/or a small radius of curvature, which features may suggest pressing of molten glass to form said articles. The system and method disclosed herein are unique in that the same solid lubricant is configured to strongly reduce friction on all effective areas of the mold assembly during the compression induced by the plunger stroke so as to extend the process window and enable formation of significantly thinner 3D-shaped glass articles. In other words, for a given press, process conditions, and glass composition, forming a thin, 3D-shaped glass article becomes feasible using the system and the method disclosed herein. The use of other solid lubricants, such as carbon or boron nitride powder, can be contemplated within the present disclosure.

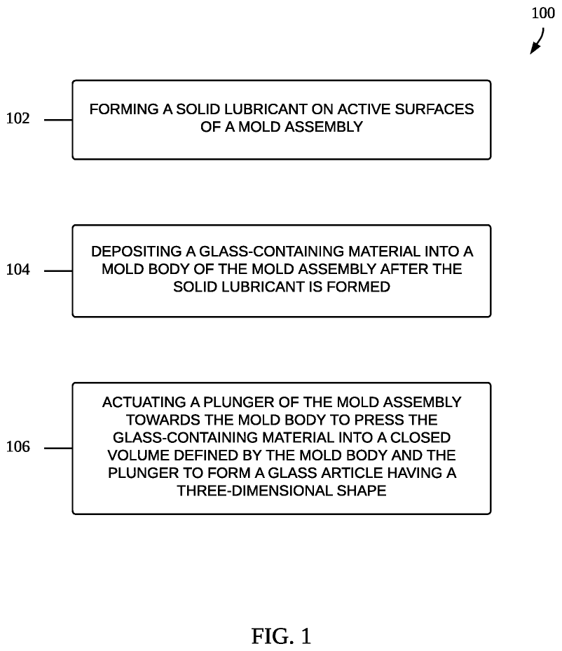

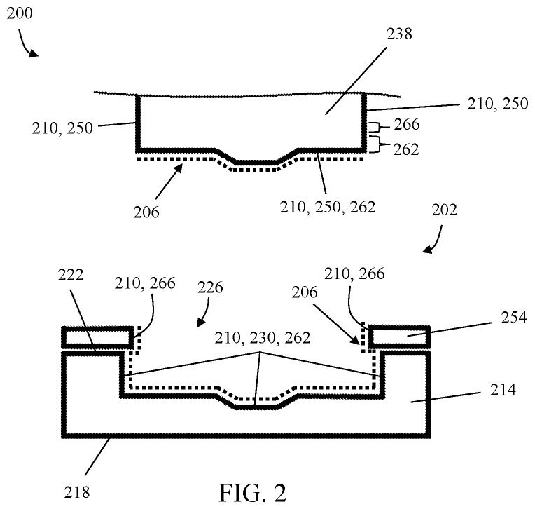

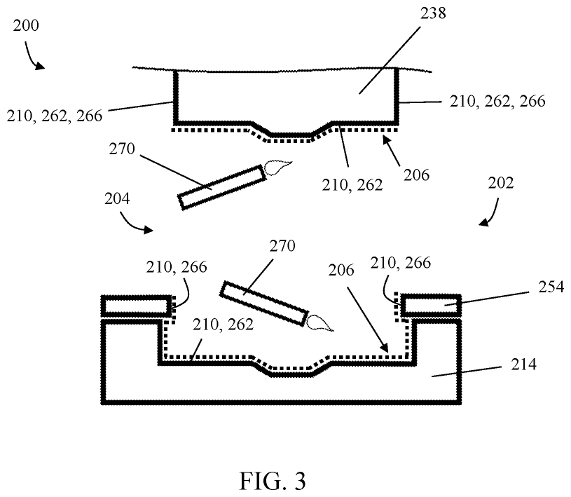

FIG. 1 shows a flow chart of a method 100 for forming a thin, three-dimensional shaped glass article via pressing. The method 100 is further described with reference to FIGS. 2-6, which include cross-sectional representations of a system 200 comprising a mold assembly 202 and a burner assembly 204 (FIG. 3) with the system 200 configured to perform various aspects of the method 100 according to the present disclosure. The method 100 comprises forming a solid lubricant 206 on active surfaces 210 of the mold assembly 202 (block 102 of FIG. 1). The mold assembly 202, as shown in FIG. 2, comprises a mold body 214 with a bottom end 218 and a top end 222 disposed opposite the bottom end 218. In embodiments, the mold body 214 has an open cavity 226 within which one or more mold surfaces 230 of the mold body 214 are configured to define a mold pattern (not labeled). The open cavity 226 opening to the top end 222 of the mold body 214 in embodiments.

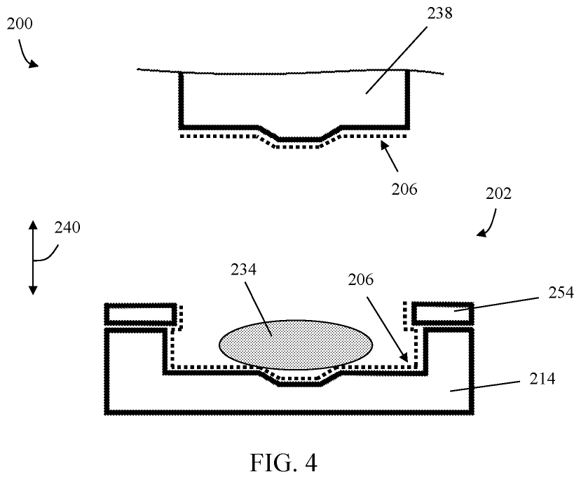

Referring to FIGS. 1 and 4, the method 100 further comprises depositing a glass-containing material 234 in a molten state (also referred to as a gob) into the open cavity 226 of the mold body 214 of the mold assembly 202 after forming the solid lubricant 206 on the active surfaces 210 (block 104 of FIG. 1). The glass-containing material 234 (e.g., glass or glass ceramic) can be placed at a center of the mold body 214 (also referred to as gathering), though in embodiments the glass-containing material 234 can be placed approximately at the center or spaced from the center.

In embodiments, the glass-containing material 234 is deposited into the mold body 214 according to predetermined gathering conditions. For example, a deposit of the glass-containing material (e.g., glass or glass-ceramic) configured with a target temperature, shape, and mass/weight is directed (e.g., delivered) into the mold body 214. There are several considerations for determining the target temperature, shape, and mass/weight of the glass-containing material. For instance, temperature will dictate the viscosity of the glass-containing material as it enters the mold body, and thus its ability to fill out the mold body (if desired) prior to pressing the glass-containing material with the plunger. Another consideration is the die design (e.g., the mold pattern and the plunger pattern), which includes the thickness, tightness of tolerances and/or scale of the features in the die design (e.g., how far the glass has to travel and/or the size or smallness of the features). Another consideration is the amount of pressure generated on the molten glass-containing material via the pressing force. The gathering conditions are configured to be compatible with the specifications of the mold assembly 202.

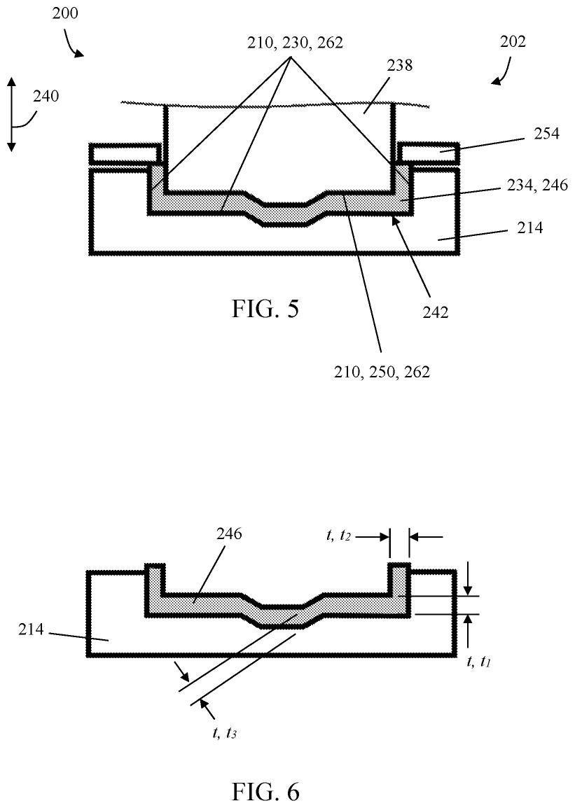

Referring to FIGS. 1, 4, and 5, the method 100 further comprises actuating a plunger 238 of the mold assembly 202 towards the mold body 214 and into the open cavity 226 to press the glass-containing material 234 into a closed volume 242 to form the glass article 246. In embodiments, the plunger 238 is configured to translate along an axis (arrow 240 in FIG. 5) towards the mold body 214 in a first direction when actuated to press the glass-containing material 234 into the closed volume 242. The plunger 238 is configured to translate along the axis (arrow 240 in FIG. 5) away from the mold body 214 in a second direction opposite the first direction when actuated to release the glass article 246 from the mold assembly 202. The plunger 238, as shown in FIG. 4, has plunger surfaces 250 with at least some of the plunger surfaces 250 configured to define a plunger pattern (not labeled). The closed volume 242 is defined by the mold body 214 (e.g., the mold pattern) and the plunger 238 (e.g., the plunger pattern).

In embodiments, the closed volume 242 has a three-dimensional shape such that when the glass-containing material 234 is pressed into the closed volume 242, the glass article 246 is formed with the three-dimensional shape of the closed volume 242. Each of the mold pattern and the plunger pattern has a configuration of features that is imparted/formed (e.g., in the negative) into respective areas or regions of the glass-containing material 234 when pressed by the plunger 238 so as the form the glass article 246 with a near net or net shape (i.e., with minimal or no post-processing). The surfaces of the glass article 246 imparted/formed via the mold pattern and the plunger pattern can be planar and/or curved in portions though the surfaces are preferably configured with the three-dimensional shape.

The mold assembly 202 in embodiments can further comprise a ring portion 254 configured to cover a portion, such as a peripheral portion, of the open cavity 226 of the mold body 214. The ring portion 254 is configured to define a portion of the closed volume 242. For example, when the plunger 238 is actuated towards the mold body 214 and presses the glass-containing material 234, the glass-containing material 234 is squeezed between the plunger pattern of the plunger 238 and the mold pattern of the mold body 214 with portions of the glass-containing material 234 moving laterally outwardly until contact with the ring portion 254. In embodiments, the ring portion 254 is separate from (i.e., not an integral part of) the mold body 214 and the plunger 238. In such embodiments, the ring portion is disposed on the mold body 214 (e.g., on the top end 222 of the mold body 214) and configured to define a ring opening 258 through which the plunger 238 moves and makes sliding contact with the ring portion 254 when the plunger 238 is actuated during a pressing operation.

During a pressing operation while the plunger 238 is actuated towards the mold body 214, the closed volume 242 (also referred to as a compression volume) decreases or reduces until the plunger 238 is actuated to or reaches a predetermined distance from the mold body 214, such as position of the plunger 238 shown in FIG. 5. The plunger 238 is actuated with a pressing force configured to ensure the plunger 238 reaches the predetermined distance and the glass-containing material 234 is pressed so as to completely fill closed volume 242. In embodiments, the plunger 238 is actuated with a pressing force less than or equal to 16.7 kN, or 15.7 kN, or 14.7 kN, or 13.7 kN, or 12.7 kN, or 11.8 kN, or 10.8 kN, or 9.8 kN. In embodiments, the plunger 238 is actuated with a pressing force greater than or equal to 1.5 kN, or 2.0 kN, or 2.5 kN, or 3 kN, or 3.4 kN, or 3.9 kN, or 4.4 kN, or 4.9 kN.

It should be appreciated that the pressing force used during the pressing operation can depend on the shape, the aspect ratio, and the thickness (among other attributes or factors) of the glass article 246 to be formed, and different pressing forces (e.g., larger or smaller) can be used in embodiments of the method. For example, embodiments of the method are contemplated in which the plunger 238 is actuated with a pressing force in range as low as 1 kN and as high as 100 kN even when the solid lubricant 206 is formed on the active surfaces 210 of the mold assembly 202. In such embodiments, the plunger 238 can be actuated with a pressing force in a range of from about 1 kN to about 75 kN, or from about 1 kN to about 50 kN, or from about 1 kN to about 25 kN, or from about 25 kN to about 100 kN, or from about 50 kN to about 100 kN, or from about 75 kN to about 100 kN, or from about 2 kN to about 90 kN, or from about 4 kN to about 80 kN, or from about 5 kN to about 70 kN, or from about 10 kN to about 60 kN, and also comprising all sub-ranges and sub-values between these range endpoints.

The active surfaces 210 of the mold assembly 202 are further described with reference to FIG. 5. In particular, the mold assembly 202 comprises first surfaces 262 that define the closed volume 242 and one or more pairs of second surfaces 266 that make sliding contact during actuation of the plunger 238. The closed volume 242 is shown with gray shading in FIG. 5. Since the first surfaces 262 define the closed volume 242, the first surfaces 262 comprise any surfaces or surface portions of the mold body 214, the plunger 238, and the ring portion 254 that bound the closed volume 242, as indicated in FIG. 5. The active surfaces 210 include all of the first surfaces 262.

The second surfaces 266 are pairs of surfaces that make sliding contact during the actuation of the plunger 238. As shown in FIG. 5, surfaces of the ring portion 254 that define the ring opening 258 make sliding contact with a portion of the (vertical) plunger surfaces surrounded by the ring opening 258. As such, the noted surfaces of the plunger 238 and the ring portion 254 constitute second surfaces 266 at the position of the plunger 238 depicted in FIG. 5. The active surfaces 210 include at least one second surface 266 of each of the one or more pairs of second surfaces 266 (i.e., the noted surface of the plunger 238 and/or the noted surface of the ring portion 254).

It should be appreciated that some surfaces of the mold assembly 202 can be first surfaces 262 and second surfaces 266. For example, when the plunger 238 is first inserted through the ring opening 258, surfaces of the plunger 238 at a tip portion of the plunger 238 make sliding contact with surfaces of the ring portion 254 that define the ring opening 258. As such, the noted surfaces of the plunger 238 and the ring portion 254 would constitute second surfaces 266 at the noted position of the plunger 238. As the plunger 238 is further actuated towards the mold body 214, the surfaces of the plunger 238 at the tip portion no longer make sliding contact with the surfaces of the ring portion 254 that define the ring opening 258, for example, at the position of the plunger 238 depicted in FIG. 5. Instead, the surfaces of the plunger 258 at the tip portion now define the closed volume 242. Thus, the noted surfaces of the plunger 238 would constitute first surfaces 262 at the position of the plunger 238 depicted in FIG. 5.

The burner assembly 204 of the system 200 is further described with reference to FIGS. 2 and 3. The burner assembly 204 in embodiments comprises one or more burners, such as multi-port burners 270 schematically illustrated in FIG. 3. The burner assembly 204 is configured to form the solid lubricant 206 in a continuous layer on the active surfaces 210. The continuous layer of the solid lubricant 206 is depicted as a continuous dotted line positioned adjacent to the active surfaces 210. As shown in FIGS. 2 and 3, there is a first continuous layer of the solid lubricant 206 disposed on the active surfaces 210 of the plunger 238 and a second continuous layer of the solid lubricant 206 disposed on the active surfaces 210 of the mold body 214 and the ring portion 254. The continuous layer of the solid lubricant 206 can have any thickness that is useful for modifying the friction conditions between the glass-containing material and the active surfaces 210 of the mold assembly 202. In embodiments, the continuous layer of the solid lubricant 206 can have a thickness that approximates the thickness of the individual particles of the solid lubricant. In embodiments, the continuous layer of the solid lubricant 206 has a thickness of a few nanometers, tens of nanometers, hundreds of nanometers, a few microns, tens of microns, or hundreds of microns.

In embodiments, the solid lubricant 206 is carbon soot formed in a continuous layer on the active surfaces 210. In embodiments, the carbon soot is formed by thermally decomposing a hydrocarbon, such as a hydrocarbon gas, using a flame. In embodiments, the hydrocarbon is thermally decomposed by selectively pulsing a supply of the hydrocarbon to the multi-port burner(s) 270 with the flame to form the carbon soot. In embodiments, the flame is maintained by continuously supplying natural gas to the multi-port burner(s) 270 when the multi-port burner(s) 270 are not pulsed with the hydrocarbon to form the carbon soot. In embodiments, the hydrocarbon is acetylene. In such embodiments, the solid lubricant 206 that results from thermally decomposing the acetylene is acetylene black.

As best shown in FIG. 6, the closed volume 242 is configured to form the glass article 246 with a thickness t when the plunger 238 is at the predetermined distance. The glass article 244 can have a thickness t at different regions thereof, such as a first thickness t₁ at a vertical-extending region, a second thickness t₂ at a horizontal-extending region, and a third thickness t₃ at a diagonal-extending region. In embodiments, the first (t₁), second (t₂), and third (t₃) thicknesses can be the same (e.g., such that the glass article 244 has a constant thickness over its extent) or different (e.g., such that the glass article 244 has a variable thickness over its entire extent or over portions thereof).

In embodiments, the closed volume 242 is configured to form the glass article 244 with a thickness t of less than or equal to approximately 4 mm, or 3.75 mm, or 3.5 mm, or 3.25 mm, or 2 mm, or 1.75 mm, or 1.5 mm, or 1.4 mm, or 1.25 mm, or 1.15 mm, or 1.05 mm, or 1 mm, or with a thickness t of greater than or equal to approximately 0.25 mm, or 0.3 mm, or 0.35 mm, or 0.5 mm, or 0.6, mm, or 0.75 mm, or 0.8 mm, or 0.9 mm.

In embodiments, the ring portion 254 can be integral with and/or connected to the plunger 238 such that the ring portion 254 moves with the plunger 238 during actuation of the plunger 238. In such embodiments, the ring portion 254 is configured to contact the mold body 214 to define the closed volume 242 at least when the plunger 238 is positioned at the predetermined distance.

### EXAMPLES

Various embodiments of the present disclosure can be better understood by reference to the following Examples which are offered by way of illustration. The present disclosure is not limited to the Examples given herein.

### Example 1

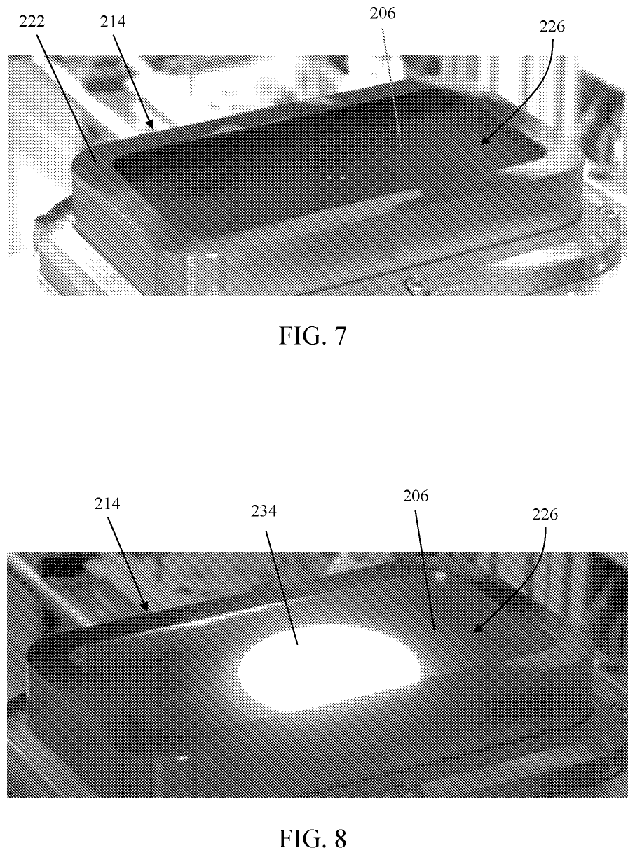

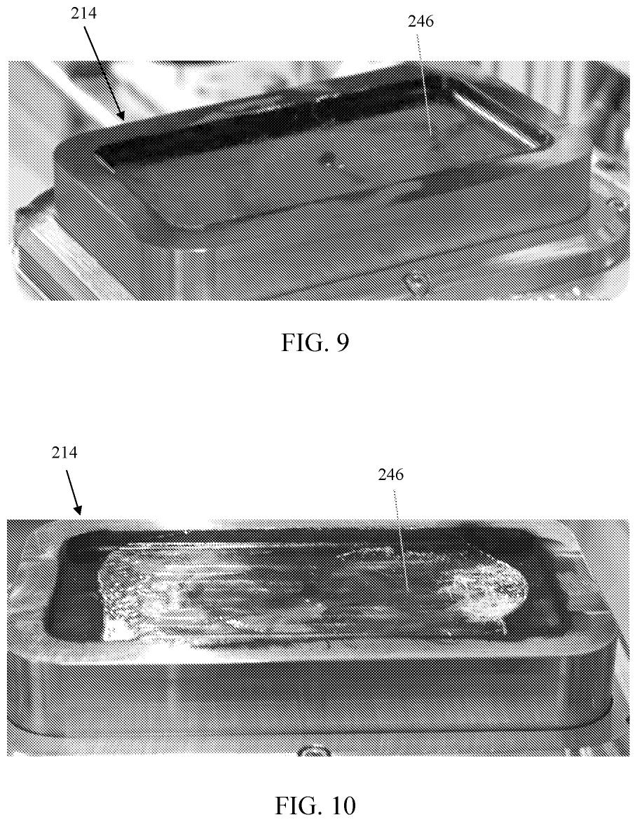

FIGS. 7-9 illustrate use of the system and the method disclosed herein to form a thin, 3D-shaped glass article via pressing. FIG. 7 is an image of the open cavity 226 of the mold body 214 comprising the solid lubricant 206 (e.g., acetylene black) formed in a continuous layer on the active surfaces 210 of the mold body 214. The mold body 214 was paired with a plunger (not shown) that cooperates with the mold body 214 to define the closed volume configured to form the glass article. FIG. 8 is an image of the glass-containing material 234 deposited into the open cavity 226 at the center of the mold body 214. The glass-containing material or gob 234 had a mass of approximately 50 g in Example 1. The ring portion (not shown) was then positioned on the top end 222 of the mold body 214, and the plunger was inserted through the ring opening (not shown). The plunger was then actuated towards the mold body 214 to press the gob 234 into the closed volume. In Example 1, the plunger was actuated with a pressing force of approximately 500 kgf (equivalent mass) or approximately 4.9 kN. FIG. 9 is an image of the 3D-shaped glass article completely formed while remaining in the mold body 214 after actuating/pressing of the plunger and with the plunger and the ring portion removed. In Example 1, the 3D-shaped glass article 246 had a thickness of approximately 1.4 mm and a surface area of approximately 160 mm by 80 mm. The pressing pressure on the surface of the glass article at the point when the molten gob is pressed with the pressing force (e.g., about 4.9 kN) to completely fill the closed volume between the mold body and the plunger is approximately 0.383 MPa.

### Example 2

The same mold assembly from Example 1 was used to attempt formation of another thin, 3D-shaped glass article. However, the solid lubricant 206 present in the mold body 214 in Example 2 was residues associated with prior pressing, for example, according to Example 1. In other words, the solid lubricant 206 was not replenished during the pressing of Example 2. Using the same pressing parameter as described above with respect to Example 1, except with regard to the solid lubricant, the resulting glass article 244 was incompletely formed, as shown in FIG. 10. In particular, the glass-containing material or gob 234 in Example 2 was not sufficiently squeezed laterally outwardly from the center of the mold body 214 to fill the closed volume formed by the mold body 214 and the plunger. The technical effect of the solid lubricant 206 is apparent in that a larger pressing force than that used in Example 1 would be required to fully form the glass article in the mold body when only residues of the solid lubricant remaining on the active surfaces thereof.

### Example 3

A thin, 3D-shaped glass article was formed via pressing using the mold assembly of Example 1 with the solid lubricant (e.g., acetylene black) formed in a continuous layer on the active surfaces of the mold body. The glass-containing material or gob had a mass of approximately 49 g in Example 3. The plunger was actuated with a pressing force of approximately 1000 kgf or approximately 9.8 kN. The 3D-shaped glass article that resulted from the pressing according to Example 3 had a thickness of approximately 1 mm and a surface area of approximately 160 mm by 80 mm. The pressing pressure on the surface of the glass article at the point when the molten gob is pressed with the pressing force (e.g., about 9.8 kN) to completely fill the closed volume between the mold body and the plunger is approximately 0.766 MPa. In a further experiment, a larger pressing force, such as a pressing force of 50 kN, could be used to form the 3D-shaped glass article according to Example 3. The pressing pressure on the surface of the glass article at the point when the molten gob is pressed with the larger pressing force (e.g., about 50 kN) to completely fill the closed volume between the mold body and the plunger is approximately 4.0 MPa.

While the disclosure has been illustrated and described in detail in the drawings and foregoing description, the same should be considered as illustrative and not restrictive in character. It is understood that only the preferred embodiments have been presented and that all changes, modifications, and further applications that come within the spirit of the disclosure are desired to be protected.

1. A method for forming a glass article, comprising:
forming a solid lubricant on active surfaces of a mold assembly;
depositing a glass-containing material in a molten state into an open cavity of a mold body of the mold assembly after forming the solid lubricant on the active surfaces;
actuating a plunger of the mold assembly towards the mold body and into the open cavity to press the glass-containing material into a closed volume defined by the mold body and the plunger to form the glass article, the closed volume having a three-dimensional shape,
wherein the mold assembly comprises (i) first surfaces that define the closed volume and (ii) one or more pairs of second surfaces that make sliding contact during the actuating of the plunger, the active surfaces comprising all of the first surfaces and at least one second surface of each of the one or more pairs of second surfaces.

2. The method of claim 1, wherein the solid lubricant is carbon soot formed in a continuous layer on the active surfaces.

3. The method of claim 2, wherein the carbon soot is formed by thermally decomposing a hydrocarbon using a flame.

4. The method of claim 3, wherein the thermally decomposing the hydrocarbon comprises selectively pulsing a supply of the hydrocarbon to a multi-port burner with the flame to form the carbon soot.

5. The method of claim 4, wherein, when not pulsing the supply of the hydrocarbon, the flame is maintained by continuously supplying natural gas to the multi-port burner.

6. The method of claim 3, wherein the hydrocarbon is acetylene.

7. The method of claim 1, wherein the closed volume decreases until the plunger is actuated to a predetermined distance from the mold body, the closed volume configured to form the glass article with a thickness of less than or equal to approximately 2 mm when the plunger is at the predetermined distance.

8. The method of claim 7, wherein the thickness varies over at least a portion of the glass article.

9. (canceled)

10. The method of claim 1, wherein the mold assembly further comprises a ring portion that covers a peripheral portion of the open cavity of the mold body, the ring portion defining a portion of the closed volume.

11. (canceled)

12. The method of claim 10, wherein the ring portion is separate from the mold body and the plunger, the ring portion disposed on the mold body and defining a ring opening through which the plunger moves and makes sliding contact with the ring portion during the actuating of the plunger.

13. A system for forming a glass article, comprising:
a mold assembly comprising a mold body and a plunger, the mold body defining an open cavity configured to receive a glass-containing material in a molten state, the plunger configured to be actuated towards the mold body and into the open cavity to press the glass-containing material into a closed volume defined by the mold body and the plunger to form the glass article, the closed volume having a three-dimensional shape; and
a burner assembly configured to form a solid lubricant on active surfaces of the mold assembly, the mold assembly further comprising (i) first surfaces that define the closed volume and (ii) one or more pairs of second surfaces configured to make sliding contact when the plunger is actuated towards the mold body, the active surfaces comprising all of the first surfaces and at least one second surface of each of the one or more pairs of second surfaces.

14. The system of claim 13, wherein the solid lubricant is carbon soot disposed in a continuous layer on the active surfaces.

15. The system of claim 14, wherein the burner assembly comprises a multi-port burner configured to form the carbon soot by thermally decomposing a hydrocarbon using a flame.

16. The system of claim 15, wherein the burner assembly is configured to provide a pulsed supply of the hydrocarbon to the multi-port burner to form the carbon soot.

17. The system of claim 15, or wherein the burner assembly is configured to provide a continuous supply of natural gas to the multi-port burner to maintain the flame.

18. The system of claim 15, wherein the hydrocarbon is acetylene.

19. The system of claim 13, wherein the closed volume decreases until the plunger is actuated to a predetermined distance from the mold body, the closed volume configured to form the glass article with a thickness of less than or equal to approximately 2 mm when the plunger is at the predetermined distance.

20. The system of claim 19, wherein the thickness varies over at least a portion of the glass article.

21. (canceled)

22. The system of claim 13, wherein the mold assembly further comprises a ring portion that covers a peripheral portion of the open cavity of the mold body, the ring portion defining a portion of the closed volume.

23. (canceled)

24. The system of claim 22, wherein the ring portion is separate from the mold body and the plunger, the ring portion disposed on the mold body and defining a ring opening through which the plunger moves and makes sliding contact with the ring portion when the plunger is actuated towards the mold body.
